(19) United States
(12) Patent Application Publication
(10) Pub. No.: US 2024/0320100 A1
(43) Pub. Date: Sep. 26, 2024

(54) WARM RESTART IN A NETWORK PROCESSOR DEVICE

(71) Applicant: Intel Corporation, Santa Clara, CA (US)

(72) Inventors: Robert Valiquette, Carignan (CA); Alexandre Hamel, Brossard (CA); Benoit Roy, Pierrefonds (CA); Michel Noiseux, Brossard (CA); Simon Perron Caissy, Saint-Constant (CA); Benjamin H. Shelton, Eugene, OR (US)

(73) Assignee: Intel Corporation, Santa Clara, CA (US)

(21) Appl. No.: 18/731,175

(22) Filed: May 31, 2024

Related U.S. Application Data
(60) Provisional application No. 63/611,102, filed on Dec. 15, 2023.

(51) Int. Cl. G06F 11/14; H04L 67/00; H04L 69/28

(52) U.S. Cl. CPC G06F 11/1438; H04L 67/34; H04L 69/28

(57) ABSTRACT

A warm restart is initiated at a network processor device, which includes a switch, one or more hardware components, and physical layer circuitry to implement one or more communication links. The switch is to be reset during the warm restart while the one or more communication links remain in an up state. A notification of the warm restart is sent to a set of drivers for the one or more hardware components and notifications are received from the set of drivers, where the notifications identify that reinitializations of the hardware components in association with the warm restart are complete. An indication is sent that the reinitializations of the hardware components are complete, where completion of the warm restart based on the indication.

### CROSS-REFERENCE TO RELATED APPLICATIONS

This application claims priority to, and the benefit of, U.S. Provisional Application No. 63/611,102, filed on Dec. 15, 2023, and entitled “WARM RESET IN WIRELESS BASE STATION SYSTEM.” The prior application is hereby incorporated by reference in its entirety.

### BACKGROUND

The use of personal communication devices has increased astronomically over the last two decades. The penetration of mobile devices (user equipment or UEs) in modern society has continued to drive demand for a wide variety of networked devices in a number of disparate environments. The use of networked UEs using 3GPP LTE systems has increased in all areas of home and work life. As reliance on such mobile networks increases, user expectations of reliability and performance also increase for the elements of the network.

### BRIEF DESCRIPTION OF THE DRAWINGS

FIG. 1 illustrates a block diagram of an example communication system in accordance with certain embodiments.

FIG. 2 is a simplified block diagram of an example architecture of a radio access network.

FIG. 3 is a simplified block diagram illustrating an example networking device.

FIG. 4 is a simplified block diagram illustrating an example communication system.

FIG. 5 is a simplified block diagram illustrating an example network processor device.

FIG. 6 is a simplified flow diagram illustrating an example technique for performing a warm restart in a network processor device.

FIG. 7 illustrates a block diagram of an example processor device in accordance with certain embodiments.

Like reference numbers and designations in the various drawings indicate like elements.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

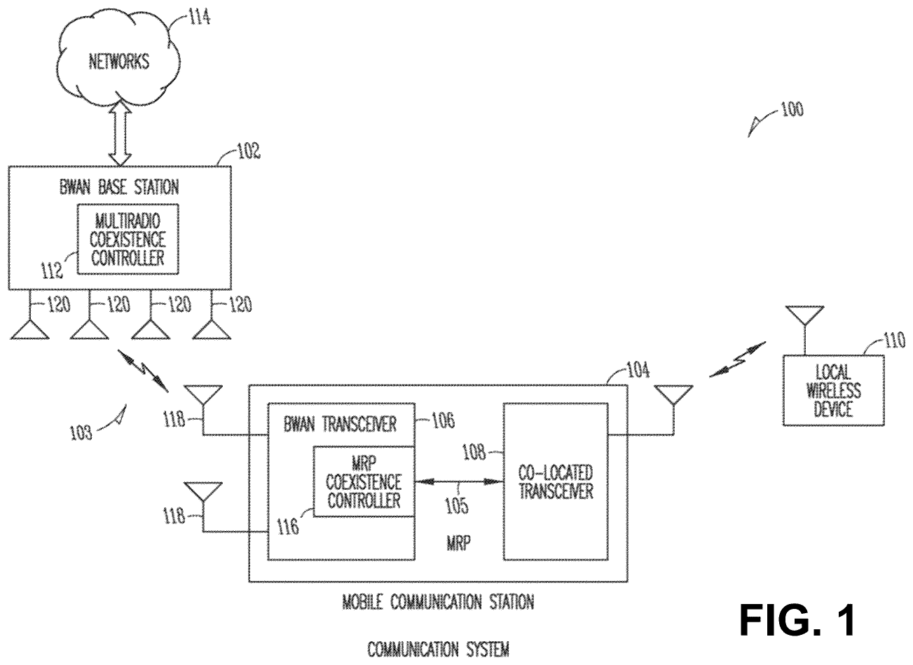

FIG. 1 is a functional block diagram of communication system in accordance with some embodiments. Communication system 100 includes broadband wireless access network (BWAN) base station 102, mobile communication station 104 and local wireless device 110. Mobile communication station 104 may be a multi-radio platform (MRP) and may include BWAN transceiver 106 and co-located transceiver 108. BWAN transceiver 106 may be configured to communicate with BWAN base station 102 using BWAN frames 103. Co-located transceiver 108 may be configured to communicate with one or more local devices, such as local wireless device 110. Co-located transceiver 108 may include one or more local transceivers described in more detail below. Co-located transceiver 108 may, among other things, discover local wireless device 110, establish a connection with local wireless device 110, and communicate with local wireless device 110, as described in more detail below. BWAN base station 102 may be coupled with one or more networks 114, which may include an access service network, the Internet and a telephone network to provide communications between networks 114 and mobile communication device 104.

In accordance with embodiments, mobile communication device 104 includes MRP coexistence controller 116 to interface with BWAN transceiver 106 and co-located transceiver 108 over internal radio interface 105. BWAN base station 102 may include multi-radio coexistence controller 112 for coordinating coexistence activities with MRP coexistence controller 116. In accordance with some embodiments, MRP coexistence controller 116 may be configured to allow BWAN transceiver 106, BWAN base station 102 and co-located transceiver 108 to cooperate in a time-division multiplexed (TDM) fashion by collaboratively coordinating activities of these multiple transceivers to avoid mutual interference. These embodiments are described in more detail below. In some embodiments, MRP coexistence controller 116 may be part of BWAN transceiver 106, although the scope of the embodiments is not limited in this respect.

In accordance with some embodiments, MRP coexistence controller 116 is configured to generate a co-located coexistence (CLC) request message in response to a request from co-located transceiver 108. The CLC request message may be transmitted to multi-radio coexistence controller 112 of BWAN base station 102 to reserve time for communications by co-located transceiver 108. In these embodiments, the CLC request message may include parameters for a requested CLC class. During the reserved time, BWAN base station 102 may be configured to refrain from scheduling communications with BWAN transceiver 106.

In some embodiments, the CLC request message transmitted to BWAN base station 102 may be a request to reserve time within BWAN frames 103 to allow interference-free communications by co-located transceiver 108 and local wireless device 110. In some embodiments, BWAN base station 102 may be configured to refrain from scheduling communications within an active interval which occurs during portions of BWAN uplink or downlink subframes of BWAN frames 103.

In some embodiments, the CLC request messages sent by mobile communication device 104 and the CLC response messages sent by BWAN base station 102 may comprise mobile (MOB) management messages or management frames in accordance with the communication standards applicable to the BWAN.

In some embodiments, mobile communication device 104 may operate as a wireless mobile communication device in a BWAN. In these embodiments, CLC class operations provide for periodic time intervals granted by BWAN base station 102 in which asynchronous downlink or/and uplink allocations of unicast transmissions in a connected state may be prohibited to protect operations of co-located transceiver 108. CLC class operations may avoid impacting broadcast and multicast traffic as well as synchronous (e.g., periodic) unicast traffic for mobile communication station 104.

Mobile communication station may be almost any wireless communication device including a desktop, laptop or portable computer with wireless communication capability, a web tablet, a wireless or cellular telephone, an access point or other device that may receive and/or transmit information wirelessly. Although the various entities of mobile communication device 104 and BWAN base station 102 are illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, application-specific integrated circuits (ASICs), radio-frequency integrated circuits (RFICs) and combinations of various hardware and logic circuitry for performing at least the functions described herein. In some embodiments, the functional elements of mobile communication device 104 and BWAN base station 102 illustrated in FIG. 1 may refer to one or more processes operating on one or more processing elements.

The term “BWAN” may refer to devices and networks that communicate using any broadband wireless access communication technique, such as orthogonal frequency division multiple access (OFDMA), that may potentially interfere with the spectrum utilized by co-located transceiver 108, including interference due to out-of-band (OOB) emissions. In some embodiments, BWAN transceiver 106 may be a Worldwide Interoperability for Microwave Access (WiMAX) transceiver and BWAN base station 102 may be a WiMAX base station configured to communicate in accordance with at least some Electrical and Electronics Engineers (IEEE) 802.16 communication standards for wireless metropolitan area networks (WMANs) including variations and evolutions thereof, although the scope of the embodiments is not limited in this respect. For more information with respect to the IEEE 802.16 standards, please refer to “IEEE Standards for Information Technology—Telecommunications and Information Exchange between Systems” Metropolitan Area Networks—Specific Requirements—Part 16: “Air Interface for Fixed Broadband Wireless Access Systems,” May 2005 and related amendments and versions thereof.

In some other embodiments, BWAN transceiver 106 and BWAN base station 102 may communicate in accordance with at the 3rd Generation Partnership Project (3GPP) Universal Terrestrial Radio Access Network (UTRAN) Long Term Evolution (LTE) communication standards, release 8, March 2008, including variations and evolutions thereof, although the scope of the embodiments is not limited in this respect.

Co-located transceiver 108 may include one or more transceivers including one or more of a Bluetooth, a wireless local area network (WLAN) and a Wireless Fidelity (WiFi) transceiver. The WLAN and WiFi transceivers may communicate in accordance with the IEEE 802.11(a), 802.11(b), 802.11(g), 802.11(h) and/or 802.11(n) standards and/or proposed specifications. For more information with respect to the IEEE 802.11 standards, please refer to “IEEE Standards for Information Technology-Telecommunications and Information Exchange between Systems”—Local Area Networks-Specific Requirements—Part 11 “Wireless LAN Medium Access Control (MAC) and Physical Layer (PHY), ISO/IEC 8802-11: 1999” and related amendments/versions.

Bluetooth, as used herein, may refer to a synchronous short-range digital communication protocol including a short-haul wireless protocol frequency-hopping spread-spectrum (FHSS) communication technique operating in the 2.4 GHz spectrum. The use of the terms WiFi, WLAN, Bluetooth, WiMAX and LTE are not intended to restrict the embodiments to any of the requirements of the standards and specifications relevant to WiFi, Bluetooth, and WiMax.

In some multiple-input, multiple-output (MIMO) embodiments, BWAN transceiver 106 may use two or more antennas 118 for communications and BWAN base station 102 may use two or more antennas 120 for communications. In these embodiments, antennas 118 may be effectively separated from each other and antennas 120 may be effectively separated from each other to take advantage of spatial diversity and the different channel characteristics that may result between each of antennas 118 and each of antennas 120. Antennas 118 and 120 may comprise one or more directional or omnidirectional antennas, including, for example, dipole antennas, monopole antennas, patch antennas, loop antennas, microstrip antennas or other types of antennas suitable for transmission of RF signals. In some embodiments, instead of two or more antennas, a single antenna with multiple apertures may be used. In these embodiments, each aperture may be considered a separate antenna. In some embodiments, antennas 118 and antennas 120 may be separated by up to 1/10 of a wavelength or more.

Some embodiments are directed to a BWAN. These embodiments may include a plurality of mobile communication stations, such as mobile communication station 104, and a BWAN base station, such as BWAN base station 102. At least one of the mobile communication stations includes a MRP including a BWAN transceiver and a co-located transceiver. In these embodiments, the BWAN transceiver includes a MRP coexistence controller. The BWAN base station may be configured to respond to a CLC request message from the BWAN transceiver to reserve time for interference-free communications by the co-located transceiver. In these embodiments, the CLC request message may include parameters for a requested CLC class. When the requested CLC class is accepted, the BWAN base station may refrain from scheduling communications with the BWAN transceiver during an active interval based at least in part based on the parameters of the CLC request message to allow interference-free communications between the co-located transceiver and a local wireless device.

In some WiMAX embodiments, BWAN base station 102 communicates with mobile communication station 104 within OFDMA downlink and uplink subframes 103, and the active interval occur during a plurality of the downlink and uplink subframes. In these embodiments, the downlink and uplink subframes and time-division multiplexed comprise a same set of a plurality of frequency subcarriers.

A BWAN system, among other embodiments described herein may be related to one or more third generation partnership project (3GPP) specifications. Examples of these specifications include, but are not limited to, one or more 3GPP new radio (NR) specifications and one or more specifications directed and/or related to Radio Layer 1 (RAN1), Radio Layer 2 (RAN2), and/or fifth generation (5G) mobile networks/systems. A study item (SI) in NR to enhance a disaggregated gNodeB (or gNB) architecture has an objective to enhance packet data convergence protocol (PDCP) protocol data unit (PDU) retransmissions and associated flow control between a Central Unit (CU) and a Distributed Unit (DU).

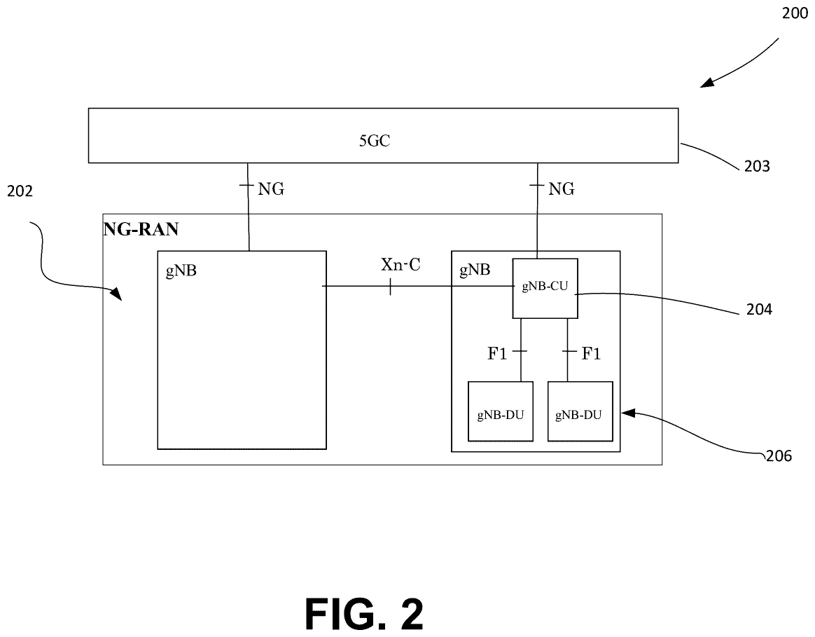

FIG. 2 shows an example of a general architecture of a NR radio access network (NR-RAN) 200. The NG-RAN 200 includes a set of gNBs 202 connected to the 5G core network (5GC) 203 through the next generation (NG) interface. An gNB can support frequency division duplexing (FDD) mode, time division duplexing (TDD) mode or dual mode operation. gNBs can be interconnected through the Xn interface. A gNB may consist of a gNB-Central Unit (gNB-CU) 204 and one or more gNB Distributed Unit(s) (gNB-DU(s)) 206. A gNB-CU and a gNB-DU are connected via F1 interface. One gNB-DU is connected to only one gNB-CU. In case of network sharing with multiple cell identification (ID) broadcast, each cell identity associated with a subset of Public Land Mobile Network (PLMNs) corresponds to a gNB-DU and the gNB-CU it is connected to, e.g., the corresponding gNB-DUs share the same physical layer cell resources. For resiliency, a gNB-DU may be connected to multiple gNB-CUs by appropriate implementation. NG, Xn and F1 are logical interfaces. For NG-RAN, the NG and Xn-Control (Xn-C) interfaces for a gNB including a gNB-CU and gNB-DUs terminate in the gNB-CU. For EN-DC, the S1-U (S1-User plane) and X2-C(X2-Control plane) interfaces for a gNB including a gNB-CU and gNB-DUs terminate in the gNB-CU. The gNB-CU and connected gNB-DUs are only visible as a gNB to other gNBs and to the 5GC.

To address the issue of explosive increases of the bandwidth required for the transport between the gNB-CU and gNB-DU by the introduction of massive multiple-input multiple output (MIMO) and extending the frequency bandwidth using Cloud RAN (C-RAN) deployment, the functional split between gNB-CU and gNB-DU within gNB and the corresponding open interface between these nodes has been defined. Specifically, a functional split has been adopted where the PDCP layer and above can be located in the gNB-CU, and the RLC layer and below can be located in the gNB-DU. The standard interface between them is specified as F1.

3GPP standardization has defined an open interface between the C-plane termination parts and U-plane termination parts of gNB-CU so that the functional separation between the two can be achieved even between different vendors. A node that terminates the C-plane of gNB-CU is called gNB-CU-CP, and a node that terminates the U-plane of the gNB-CU is called gNB-CU-UP. The standard interface between these nodes is specified as E1.

F1-C refers to the standard interface between the gNB-DU and a control plane of the gNB-CU, and F1-U refers to the standard interface between the gNB-DU and a user plane of the gNB-CU.

A gNB-CU refers to a logical node hosting radio resource control (RRC), Service Data Adaptation Protocol (SDAP) and PDCP protocols of the gNB or RRC, and PDCP protocols of the en-gNB, and controls the operation of one or more gNB-DUs. A en-gNB represents a version of NR gNB working under the Evolved Universal Terrestrial Radio Access-New Radio (E-UTRA NR) Dual Connectivity (EN-DC) feature, where the master is a Long Term Evolution (LTE) evolved NodeB (eNB) connected to evolved packet core (EPC). DC allows a UE to exchange data between itself and both a NR base station and a LTE base station. The gNB-CU terminates the F1 interface connected with the gNB-DU.

A gNB-DU refers to a logical node hosting RLC, medium access control (MAC) and physical (PHY) layers of the gNB or en-gNB, and its operation is partly controlled by gNB-CU. One gNB-DU supports one or multiple cells. One cell is supported by only one gNB-DU. The gNB-DU terminates the F1 interface connected with the gNB-CU. A gNB-CU-Control Plane (gNB-CU-CP) is a logical node hosting the RRC and the control plane part of the PDCP protocol of the gNB-CU for an en-gNB or a gNB. The gNB-CU-CP terminates the E1 interface connected with the gNB-CU-UP and the F1-C interface connected with the gNB-DU. A gNB-CU-User Plane (gNB-CU-UP) is a logical node hosting the user plane part of the PDCP protocol of the gNB-CU for an en-gNB, and the user plane part of the PDCP protocol and the SDAP protocol of the gNB-CU for a gNB. The gNB-CU-UP terminates the E1 interface connected with the gNB-CU-CP and the F1-U interface connected with the gNB-DU.

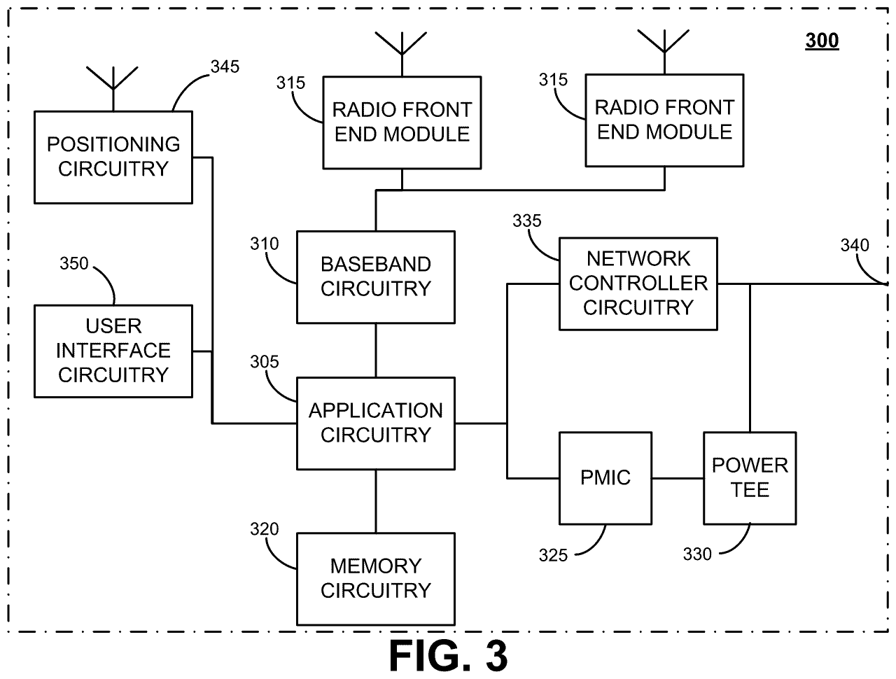

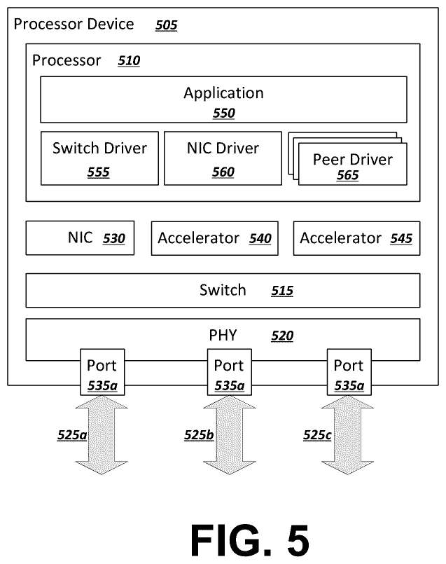

FIG. 3 illustrates an example of infrastructure equipment 300 in accordance with various embodiments. The infrastructure equipment 300 (or “system 300”) may be implemented as a base station, radio head, RAN node such as the RAN nodes and/or AP shown and described previously, application server(s), and/or any other element/device discussed herein. In other examples, the system 300 could be implemented in or by a UE. The infrastructure equipment 300 (or network system element) may include a network processor device or components of a network processor device, such as shown and discussed below in connection with FIG. 5.

The system 300 includes application circuitry 305, baseband circuitry 310, one or more radio front end modules (RFEMs) 315, memory circuitry 320, power management integrated circuitry (PMIC) 325, power tee circuitry 330, network controller circuitry 335, network interface connector 340, satellite positioning circuitry 345, and user interface 350. In some embodiments, the device 300 may include additional elements such as, for example, memory/storage, display, camera, sensor, or input/output (I/O) interface. In other embodiments, the components described below may be included in more than one device. For example, said circuitries may be separately included in more than one device for CRAN, vBBU, or other like implementations.

Application circuitry 305 includes circuitry such as, but not limited to one or more processors (or processor cores), cache memory, and one or more of low drop-out voltage regulators (LDOs), interrupt controllers, serial interfaces such as SPI, I2C or universal programmable serial interface module, real time clock (RTC), timer-counters including interval and watchdog timers, general purpose input/output (I/O or IO), memory card controllers such as Secure Digital (SD) MultiMediaCard (MMC) or similar, Universal Serial Bus (USB) interfaces, Mobile Industry Processor Interface (MIPI) interfaces and Joint Test Access Group (JTAG) test access ports. The processors (or cores) of the application circuitry 305 may be coupled with or may include memory/storage elements and may be configured to execute instructions stored in the memory/storage to enable various applications or operating systems to run on the system 300. In some implementations, the memory/storage elements may be on-chip memory circuitry, which may include any suitable volatile and/or non-volatile memory, such as DRAM, SRAM, EPROM, EEPROM, Flash memory, solid-state memory, and/or any other type of memory device technology, such as those discussed herein.

The processor(s) of application circuitry 305 may include, for example, one or more processor cores (CPUs), one or more application processors, one or more graphics processing units (GPUs), one or more reduced instruction set computing (RISC) processors, one or more Acorn RISC Machine (ARM) processors, one or more complex instruction set computing (CISC) processors, one or more digital signal processors (DSP), one or more FPGAs, one or more PLDs, one or more ASICs, one or more microprocessors or controllers, or any suitable combination thereof. In some embodiments, the application circuitry 305 may comprise, or may be, a special-purpose processor/controller to operate according to the various embodiments herein. As examples, the processor(s) of application circuitry 305 may include one or more Intel Pentium®, Core®, or Xeon® processor(s); Advanced Micro Devices (AMD) Ryzen® processor(s), Accelerated Processing Units (APUs), or Epyc® processors; ARM-based processor(s) licensed from ARM Holdings, Ltd. such as the ARM Cortex-A family of processors and the ThunderX2® provided by Cavium(TM), Inc.; a MIPS-based design from MIPS Technologies, Inc. such as MIPS Warrior P-class processors; and/or the like. In some embodiments, the system 300 may not utilize application circuitry 305, and instead may include a special-purpose processor/controller to process IP data received from an EPC or 5GC, for example.

In some implementations, the application circuitry 305 may include one or more hardware accelerators, which may be microprocessors, programmable processing devices, or the like. The one or more hardware accelerators may include, for example, computer vision (CV) and/or deep learning (DL) accelerators, networking accelerators, graphics processing accelerators, memory management accelerators, compression/decompression accelerators, cryptography accelerators, among other examples. In some implementations, the programmable processing devices may be one or more of a field-programmable devices (FPDs) such as field-programmable gate arrays (FPGAs) and the like; programmable logic devices (PLDs) such as complex PLDs (CPLDs), high-capacity PLDs (HCPLDs), and the like; ASICs such as structured ASICs and the like; programmable SoCs (PSoCs); and the like. In such implementations, the circuitry of application circuitry 305 may comprise logic blocks or logic fabric, and other interconnected resources that may be programmed to perform various functions, such as the procedures, methods, functions, etc. of the various embodiments discussed herein. In such embodiments, the circuitry of application circuitry 305 may include memory cells (e.g., erasable programmable read-only memory (EPROM), electrically erasable programmable read-only memory (EEPROM), flash memory, static memory (e.g., static random access memory (SRAM), anti-fuses, etc.)) used to store logic blocks, logic fabric, data, etc. in look-up-tables (LUTs) and the like.

The baseband circuitry 310 may be implemented, for example, as a solder-down substrate including one or more integrated circuits, a single packaged integrated circuit soldered to a main circuit board or a multi-chip module containing two or more integrated circuits.

User interface circuitry 350 may include one or more user interfaces designed to enable user interaction with the system 300 or peripheral component interfaces designed to enable peripheral component interaction with the system 300. User interfaces may include, but are not limited to, one or more physical or virtual buttons (e.g., a reset button), one or more indicators (e.g., light emitting diodes (LEDs)), a physical keyboard or keypad, a mouse, a touchpad, a touchscreen, speakers or other audio emitting devices, microphones, a printer, a scanner, a headset, a display screen or display device, etc. Peripheral component interfaces may include, but are not limited to, a nonvolatile memory port, a universal serial bus (USB) port, an audio jack, a power supply interface, etc.

The radio front end modules (RFEMs) 315 may comprise a millimeter wave (mmWave) RFEM and one or more sub-mmWave radio frequency integrated circuits (RFICs). In some implementations, the one or more sub-mmWave RFICs may be physically separated from the mmWave RFEM. The RFICs may include connections to one or more antennas or antenna arrays (see e.g., antenna array), and the RFEM may be connected to multiple antennas. In alternative implementations, both mmWave and sub-mmWave radio functions may be implemented in the same physical RFEM 315, which incorporates both mmWave antennas and sub-mmWave.

The memory circuitry 320 may include one or more of volatile memory including dynamic random access memory (DRAM) and/or synchronous dynamic random access memory (SDRAM), and nonvolatile memory (NVM) including high-speed electrically erasable memory (commonly referred to as Flash memory), phase change random access memory (PRAM), magnetoresistive random access memory (MRAM), etc., and may incorporate the three-dimensional (3D) cross-point (XPOINT) memories from Intel® and Micron®. Memory circuitry 320 may be implemented as one or more of solder down packaged integrated circuits, socketed memory modules and plug-in memory cards.

The PMIC 325 may include voltage regulators, surge protectors, power alarm detection circuitry, and one or more backup power sources such as a battery or capacitor. The power alarm detection circuitry may detect one or more of brown out (under-voltage) and surge (over-voltage) conditions. The power tee circuitry 330 may provide for electrical power drawn from a network cable to provide both power supply and data connectivity to the infrastructure equipment 300 using a single cable.

The network controller circuitry 335 may provide connectivity to a network using a standard network interface protocol such as Ethernet, Ethernet over GRE Tunnels, Ethernet over Multiprotocol Label Switching (MPLS), or some other suitable protocol. Network connectivity may be provided to/from the infrastructure equipment 300 via network interface connector 340 using a physical connection, which may be electrical (commonly referred to as a “copper interconnect”), optical, or wireless. The network controller circuitry 335 may include one or more dedicated processors and/or FPGAs to communicate using one or more of the aforementioned protocols. In some implementations, the network controller circuitry 335 may include multiple controllers to provide connectivity to other networks using the same or different protocols.

The positioning circuitry 345 includes circuitry to receive and decode signals transmitted/broadcasted by a positioning network of a global navigation satellite system (GNSS). Examples of navigation satellite constellations (or GNSS) include United States' Global Positioning System (GPS), Russia's Global Navigation System (GLONASS), the European Union's Galileo system, China's BeiDou Navigation Satellite System, a regional navigation system or GNSS augmentation system (e.g., Navigation with Indian Constellation (NAVIC), Japan's Quasi-Zenith Satellite System (QZSS), France's Doppler Orbitography and Radio-positioning Integrated by Satellite (DORIS), etc.), or the like. The positioning circuitry 345 comprises various hardware elements (e.g., including hardware devices such as switches, filters, amplifiers, antenna elements, and the like to facilitate OTA communications) to communicate with components of a positioning network, such as navigation satellite constellation nodes. In some embodiments, the positioning circuitry 345 may include a Micro-Technology for Positioning, Navigation, and Timing (Micro-PNT) IC that uses a master timing clock to perform position tracking/estimation without GNSS assistance. The positioning circuitry 345 may also be part of, or interact with, the baseband circuitry 310 and/or RFEMs 315 to communicate with the nodes and components of the positioning network. The positioning circuitry 345 may also provide position data and/or time data to the application circuitry 305, which may use the data to synchronize operations with various infrastructure (e.g., RAN nodes, etc.), or the like.

The components shown by FIG. 3 may communicate with one another using interface circuitry, which may include any number of bus and/or interconnect (IX) technologies such as industry standard architecture (ISA), extended ISA (EISA), peripheral component interconnect (PCI), peripheral component interconnect extended (PCIx), PCI express (PCIe), or any number of other technologies. The bus/IX may be a proprietary bus, for example, used in a SoC based system. Other bus/IX systems may be included, such as an I2C interface, an SPI interface, point to point interfaces, and a power bus, among others.

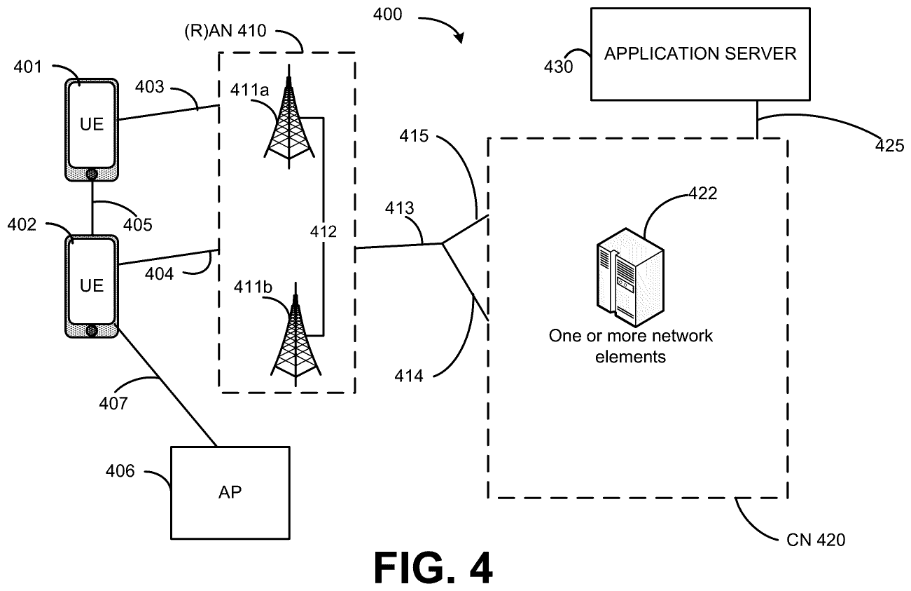

As shown by FIG. 4, an example system 400 may includes user equipment (UE) 401 and UE 402. In this example, UEs 401, 402 are illustrated as smartphones (e.g., handheld touchscreen mobile computing devices connectable to one or more cellular networks), but may also comprise any mobile or non-mobile computing device, such as consumer electronics devices, cellular phones, smartphones, feature phones, tablet computers, wearable computer devices, personal digital assistants (PDAs), pagers, wireless handsets, desktop computers, laptop computers, in-vehicle infotainment (IVI), in-car entertainment (ICE) devices, an Instrument Cluster (IC), head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, MTC devices, M2M, IoT devices, and/or the like.

The UEs 401 may be configured to connect or communicatively couple, with an or RAN 410. A RAN may include and utilize the network processor devices as discussed herein. In embodiments, the RAN 410 may be an NG RAN or a 5G RAN, an E-UTRAN, an MF RAN, or a legacy RAN, such as a UTRAN or GERAN. As used herein, the term “NG RAN” or the like may refer to a RAN 410 that operates in an NR or 5G system 400, the term “E-UTRAN” or the like may refer to a RAN 410 that operates in an LTE or 4G system 400, and the term “MF RAN” or the like refers to a RAN 410 that operates in an MF system 400. The UEs 401 utilize connections (or channels) 403 and 404, respectively, each of which comprises a physical communications interface or layer (discussed in further detail below). The connections 403 and 404 may include several different physical DL channels and several different physical UL channels. In this example, the connections 403 and 404 are illustrated as an air interface to enable communicative coupling, and can be consistent with cellular communications protocols, such as a GSM protocol, a CDMA network protocol, a PTT protocol, a POC protocol, a UMTS protocol, a 3GPP LTE protocol, a 5G protocol, a NR protocol, and/or any of the other communications protocols discussed herein. In embodiments, the UEs 401, 402 may directly exchange communication data via a wireless interface 405.

The UE 402 is shown to be configured to access an AP 406 (also referred to as “WLAN node 406,” “WLAN 406,” “WLAN Termination 406,” “WT 406” or the like) via connection 407. The connection 407 can comprise a local wireless connection, such as a connection consistent with any IEEE 802.11 protocol, wherein the AP 406 would comprise a wireless fidelity (Wi-Fi®) router (and may also include and utilize the network processor device discussed herein). In this example, the AP 406 is shown to be connected to the Internet without connecting to the core network of the wireless system (described in further detail below).

The RAN 410 can include one or more AN nodes or RAN nodes 411a and 411b (collectively referred to as “RAN nodes 411” or “RAN node 411”) that enable the connections 403 and 404. As used herein, the terms “access node,” “access point,” or the like may describe equipment that provides the radio baseband functions for data and/or voice connectivity between a network and one or more users. These access nodes can be referred to as BS, gNBs, gNodeBs, RAN nodes, eNBs, eNodeBs, NodeBs, RSUs, MF-APs, TRxPs or TRPs, and so forth, and can comprise ground stations (e.g., terrestrial access points) or satellite stations providing coverage within a geographic area (e.g., a cell). The RAN nodes 411 may be configured to communicate with one another via interface 412.

Generally, an application server 430 may be an element offering applications that use IP bearer resources with the core network (e.g., UMTS PS domain, LTE PS data services, etc.). The application server 430 can also be configured to support one or more communication services (e.g., VoIP sessions, PTT sessions, group communication sessions, social networking services, etc.) for the UEs 401 via a core network (CN) 420 (e.g., an evolved packet core (EPC), 5G Core (5GC), etc.). In some implementations, the RAN 410 may be connected with the CN 420 via an next generation (NG) interface 413. In embodiments, the NG interface 413 may be split into two parts, an NG user plane (NG-U) interface 414, which carries traffic data between the RAN nodes 411 and a UPF (e.g., the N3 and/or N9 reference points), and the S1 control plane (NG-C) interface 415, which is a signaling interface between the RAN nodes 411 and functions of the CN 420, among other example features and components.

Some wireless networking devices, such as wireless base stations and other RAN node devices may utilize processing systems including multiple components and corresponding drivers to manage both the user space/data plane and the control plane of the device. In some implementations, these processing systems may be implemented as system on chip (SoC) devices equipped with multiple IP blocks handling various functions of the RAN node. The IP blocks may have respective drivers to assist in managing links and functions for applications interfacing with and using the system (e.g., SoC).

Turning to the simplified block diagram 500 shown in the example of FIG. 5, a network processor device 505 (or simply “processor device”) is shown including a processor 510 to execute one or more networking user applications 550 (e.g., to implement a portion of a 5G or LTE network, implement routing functionality, implement a security layer for a network, implement a shared memory topology (e.g., RDMA), among other examples. The device 505 may further include a switch 515, such as an Ethernet switch or other switch according to another interconnect protocol and one or more physical layer blocks (e.g., 520) to implement (at least a portion of) ports 535a-c to support network communication links (e.g., 525a-c) to external resources on a network in accordance with an interconnect protocol. The device 505 may further include a network interface controller (NIC) 530 to be used in concert with the application 550 to send and receive data from and to the application (or the processor 510 executing the application 550) and a network or other devices via the one or more communication links 525a-c.

In some implementations, additional hardware blocks may be provided to implement various other functionality on the processor device 505 relating to network-related operations and features provided through the processor device 505 (e.g., and available for configuration and use by applications 500 executed on the one or more processors 510 of the processor device). For instance, one or more hardware accelerator blocks (e.g., 540, 545, etc.) may be included to provide hardware-accelerated functionality such as machine learning acceleration, compression/decompression, cryptography, data transforms, security (e.g., IP Protocol Security (IPSec), etc.), among various other examples. Accelerators (e.g., 540, 545) may be accessed via lookaside channels by the application 550 or in-line (e.g., by the switch 515 and/or NIC 530) to incorporate the functions and operations of one or more of the accelerators within the data flows from/to the application 550. A driver stack including drivers (e.g., 555, 560, 565, etc.) corresponding to the hardware blocks of the processor device 505 may be provided (and executed by the processor 510), including a switch driver 555 for switch 515, a NIC driver 560 for NIC 530, and associated peer drivers 565 corresponding to the various peer accelerator devices (e.g., 540, 545, etc.) provided on the processor device 505. Inter-driver communication may be provided to facilitate communication and coordination between the drivers (e.g., 555, 560, 565) and their corresponding hardware elements (e.g., switch 515, NIC 530, accelerator 540, accelerator 545, etc.). Some drivers may be implemented in user space, while others are implemented in kernel space. In some implementations, all drivers may be implemented in user space or kernel space, among other example implementations. The processor device 505, in some implementations, may be implemented as a system on chip (SoC) device, where the various hardware components (e.g., 510, 520, 530, 540, 545, etc.) on the same die or same package, or in another form factor, such as a plugin card device, among other examples.

The processor device 505 and applications (e.g., 550) run on the processor device (e.g., and using various hardware functionality provided by the other blocks (e.g., 515, 520, 530, 540, 545, etc.)) may serve as the basis of or part of a network appliance, such as a base station, RAN node, router, security appliance, or another network element. In one example, processor device 505 may be implemented as a wireless base station SoC, with a customer software application (e.g., 550) loaded to run on top of the driver stack, NIC (e.g., 530), a programmable switch (e.g., 515), accelerator blocks (crypto/compression) (e.g., 540, 545), and one or more physical network ports (e.g., 535a-c). The customer software application 505, in some implementations, may be implemented through multiple Data Plane Development Kit (DPDK) processes and handle userspace fast-path traffic through DPDK, as well as control traffic through Linux kernel netdevs. When a customer application is to be restarted (e.g., to recover from an error condition) or a new customer application is launched (for instance, as part of a software update) on the processor device 505, the respective components and their associated network resources (e.g., routing tables, configuration registers, etc.) are to be put back to a clean state. For instance, the switch tables and rules (e.g., associated with the various components and associated drivers of the SoC) may be cleaned out, and the userspace fast path support in the NIC and the accelerator blocks (for example, scheduling trees for transmitter (Tx) quality of service (QOS) and security associations for Inline IPSec) should also be cleaned up. A warm restart may be utilized to facilitate a speedy cleanup of these resources so as to avoid disruption of service.

Existing “hard” resets exist, which cause a full hardware reset of the processing system of a network processor device (e.g., 505), and thereby the network devices (e.g., a RAN node) using the processor device 505. Existing hard resets, however, may result in both the control plane and data plane being brought down and restarted, which may result in the termination of any corresponding links while the reset is being completed, resulting in additional latency and possible disruption of service. For instance, a hardware reset may require a NIC, the programmable switch, and the accelerator blocks to go through a complete reset and reinitialization sequence (e.g., a “Network Acceleration Complex (NAC) Reset”), which may result in a variety of configurations to be reset and require reconfiguration of some processes and parameters on restart (e.g., resynchronization of Precision Time Protocol (PTP) synch after the ports come back up again), which may result in additional latency before data may be sent and received using the processor device. While such full hardware restarts may be valuable and useful in certain implementations and circumstances (e.g., the replacement of the kernel driver), such restarts may be less than optimal in other instances, as it takes a significant amount of time and results in the physical ports going down. With the ports down, not only is data plane traffic turned off, but control plane traffic is also not available, among other example difficulties. In an improved solution, an example processor device (e.g., a networking SoC) may be provided with an additional warm restart option to bring down the application and user space/data plane, while preserving the configuration of the control plane and maintaining link and port connections, among other example advantages. Such a solution may be applied in various networking applications, for instance, as the organization of NIC-switch-PHY plus accelerator blocks, and the division of control-path and fast-path traffic, may have utility that is common across many networking use cases.

In one example implementation, a processor device may be implemented as an SoC for an example RAN node (e.g., wireless base station) and may include a programmable switch with a corresponding switch API from which a user application run on the SoC may call various functions, including functions corresponding to a warm restart supported by the SoC. For instance, the switch API may be responsible for starting the warm restart flow and driving the warm restart state machine by conveying the switch state and WARM_RESTART_STARTING/WARM_RESTART_COMPLETE events to various drivers in the driver stack (e.g., to one or more drivers (e.g., the NIC driver) via mailbox messages or to other drivers via inter-driver communication (IDC) messaging, among other examples). In some implementations, during warm restart, the switch API blocks any incoming API calls by setting the switch state to STATE_DOWN. The switch API then performs the warm restart, clearing out the switch rules and resetting internal structs as appropriate, with a minimal traffic drop interval for LAN flows.

Based on the architecture of the processor device, one or more components (and the corresponding driver of the component) may be a candidate for broadcasting the start of a warm restart and aggregating responses of the other components to the warm restart. As an example, in one implementation, a NIC LAN driver (e.g., 560) may be responsible for conveying the warm restart request and completion to the other peer drivers (e.g., via IDC). The NIC driver may also be responsible for handling return messages (e.g., WARM_RESTART_PEER_DRV_DONE) from peer drivers indicating that the corresponding components have completed their clean-ups and configuration tasks in association with the warm restart. In this example, the NIC driver may collect these response completion messages and notify the switch API when all the peers have completed the warm restart. If the NIC happens to encounter a Core Reset (or “CORER”) (e.g., which include a hardware configuration and datapath reset) during a warm restart window (e.g., for example, an errant cosmic ray leading to an uncorrectable bit error), then the semantics for the peer drivers may be the same as for a full reset, and the warm restart is aborted. In one example, for a full reset, the NIC driver may send an “impending reset” notification to the peer drivers, and then the peer drivers may be removed from the IDC virtual bus. If a CORER happens, it is up to the NIC LAN driver and the switch API to reset the switch as well, to ensure that the system is not left in a partially-dirty state, among other examples.

In some examples, an example NIC driver of the SoC may respond to a warm restart request in a similar manner to a hard reset. For instance, when the NIC driver receives a WARM_RESTART_STARTING IDC event it may inform any active DPDK ethdevs of an impending warm restart, and the DPDK poll-mode driver (PMD) may pass along the notification (e.g., via a standard DPDK interrupt handling mechanism) to the use application to cause the application to close out the resources the application processes are using in preparation for warm restart. In some implementations, this will cause the queue contexts, scheduler hierarchy, and hardware backpressure to be cleared in FW/HW, not just in SW.

One component of a system and its driver may be designated within a warm restart flow as responsible for notifying the other components of the system of the warm restart and collecting notifications from the other components (e.g., through communication with the components' respective drivers (e.g., using inter-driver communication channels)) that the other components have completed clean-up and other related activities associated with the warm restart. In one example, the NIC and NIC driver may be utilized to receive clean-up results from the other components. The NIC driver may interface with an API (e.g., the switch API) to report the results received from the components and assist in controlling traffic during the warm restart. As examples, for per-VSI logical to physical mapping messages conveyed to the switch API (e.g., via a mailbox), the NIC will not send these messages for any DSI VSIs closed during the warm restart interval. The switch API will be responsible for clearing out the appropriate switch tables at the beginning of the warm restart flow, after which point all incoming userspace fast-path traffic is to be dropped. For instance, one or more switch tables may be provided, which map logical ports to queues (e.g., a mapping table used to map a logical port number in the switch to a received queue number in the NIC. The mapped Rx queue number is provided by the switch to the NIC via metadata), among other examples. If the userspace dataplane (or “DSI”) ethdevs do not close all resources within a specified timeout period, the NIC driver will forcibly close them and unmap any fast-path registers from their address space, the reason being that after the warm restart, all DSI resources should be available again for applications to use. Once the DSI ethdevs have been closed, the NIC driver may send a message indicating that the peer drivers' portion of the warm restart is complete (e.g., through a IIDC_EVENT_WARM_RESTART_PEER_DRV_DONE event). The NIC driver may block any further DSI VSIs from being created (and return an error code for any such API calls). If the NIC driver is managing transmitter timestamping (e.g., as opposed to Linux netdev based Tx timestamping through NetD), the NIC driver may clear out any captured timestamps in the userspace shared memory buffer; and for any transmit timestamps captured during the warm restart interval, the NIC driver may read the timestamp to clear it, but not place the captured timestamp in the userspace shared memory buffer. In some implementations, LAN virtual functions (VFs) are considered control plane traffic (e.g., LAN traffic), so they will not be reset or removed in response to a warm restart. Accordingly, the NIC driver will not destroy the LAN VF transmit queues or scheduler hierarchy in response to a warm restart. When the NIC driver receives a WARM_RESTART_COMPLETE IDC event, the NIC driver will allow DSI VSIs to be created again and, if the NIC driver is managing transmitter timestamping, the NIC driver will once again place any captured transmit timestamps into the userspace shared memory buffer, among other example implementations and features.

An example processor device (e.g., SoC) may include cryptography and/or security hardware acceleration blocks (e.g., an inline IPSec). For instance, in some implementations, an Inline IPSec accelerator may be provided and when the corresponding Inline IPSec peer driver receives a notification of an impending warm restart it, along with other accelerator peer drivers may begin causing appropriate clean up activities to be performed at the corresponding accelerator resources. For instance, in the case of an IPSec peer driver, the peer driver may respond to the receipt of a warm restart notification by causing all security associations (SAs) associated with any active DSI VSI to be cleaned before sending its warm restart peer driver done indicator (e.g., IIDC_EVENT_WARM_RESTART_PEER_DRV_DONE) back to the driver collecting such responses (e.g., the NIC driver). Notification to the DSI applications may also occur through this driver (e.g., the NIC driver). Per the normal flow, the DSI application may be expected to close each DSI PMD ethdev via rte_eth_dev_stop( ) and rte_eth_dev_close( ) at which time the DSI PMD will call into the Inline IPSec peer driver to clean up the associated VSI's SAs. However, in the warm restart case, the DPDK DSI PMD may only call into the Inline IPSec peer driver for context cleanup, with the IPSec accelerator driver expected to clean up the corresponding SAs. If the application has already begun cleaning up its SAs through the usual (slow) path when the kernel driver cleans up all SAs, there may be some error messages logged, but these will be strictly cosmetic. If the application crashes or exits unexpectedly, no resources will be leaked, as the Inline IPSec driver will already have cleaned up any existing SAs belonging to that process. There are no negative consequences to a DSI PMD ethdev having its configured SAs cleaned up while it is still active. At this point, any ingress or egress Inline IPSec traffic will not match any configured SA, so it will be dropped internally by a corresponding switch rule. As a result, no Inline IPSec traffic will be inadvertently transmitted unencrypted and the creation of any further Sas is locked out. For instance, when the Inline IPSec peer driver receives a WARM_RESTART_COMPLETE IDC event it may allow SAs to be created again. The switch API may reconfigure crypto triggers, etc. after warm restart when the warm restart sequence starts, with the switch API caching the CRYPTO ON/OFF state. In some instances, no CRYPTO ON/OFF state change will be handled during the warm restart sequence and the switch API will restore the switch configurations to turn on crypto triggers (e.g., if that was the previous state). Therefore, the driver does not need to re-send CRYPTO_ON upon receiving WARM_RESTART_COMPLETE. This is based on the caveat that peer drivers will not be added or removed during the warm restart interval, so if Inline IPSec was there beforehand, it will be there afterwards, and vice versa. A switch API may ignore crypto on/off messages if crypto is already in the same state. If Inline IPSec is configured for the LAN VFs, warm restart will be disallowed.

In some implementations, a network processor may include a virtual interface and software switching peer driver such as a NetD block that is also notified of a warm restart. In this example, the NetD block may respond to the warm restart by clearing all timestamps that are pending to be retrieved from the PHY if NetD is handling the Tx timestamping and dropping any new timestamp-enabled packets at NetD and counting them. Transport network (TN) netdevs are not destroyed, but traffic through them is disabled. Any terminating traffic coming in from ADK from the userspace dataplane (e.g., through a userspace-to-kernel FIFO queue or ring buffer) will be dropped and counted. Any origination packets coming from Linux and destined to the userspace dataplane (e.g., an LTE application stack dataplane) will be dropped and counted. All Netlink configuration commands from userspace (such as switch netdev configuration and link status requests) will be disallowed and will return an error code. The timestamp partitioning configuration that exists before the warm restart is preserved. When these actions are completed, the corresponding peer driver may report the completion of its warm restart activities (e.g., through the sending of an IIDC_EVENT_WARM_RESTART_PEER_DRV_DONE event). When NetD receives a WARM_RESTART_COMPLETE IDC event, if NetD is handling the transmitter timestamping, it re-enables timestamping packets to flow through and TN netdevs are enabled and traffic through them can resume. The application that comes up after warm restart can set newer timestamp partitioning values. If the respawned application does not set newer partitioning values, the timestamp indices reserved for TN and internally connected (IC) ports remain the same as it was before warm restart. All traffic to and from the ADK userspace dataplane (through CPPI) will be allowed to flow. All Netlink configuration commands from userspace will be allowed again. All non-timestamping flows through NetD are considered LAN flows and will not be brought down during the warm restart process. This includes all flow directors and NIC internal switch configurations for LAN flows.

In one example, a warm restart may utilize an at least partially asynchronous flow that allows the programmable switch to be reset quickly and facilitates cleanup of the resources of the userspace, dataplane, and accelerator blocks. In some implementations, the hardware of the switch 515 may be configured to be reset and reinitialized according to a defined process. While the switch hardware is reset and reinitialized, traffic that relies on the switch is dropped. In one example, reset and reinitialization of the switch hardware may be configured to be completed with a relatively short (e.g., less than 500 ms) traffic drop window, while reset and reinitialization are completed (e.g., resetting of the switch hardware tables and other switch resources to their basic level to allow a new or updated application (e.g., 550) to configure the switch 515 for its use). Once the switch performs this brief reconfiguration, control traffic can resume. During a warm restart, this reinitialization of the switch hardware is triggered. With this traffic drop window at the switch 515 kept so short, it is expected that while some control packets or messages might be dropped, such drops will be minimal and have a limited impact on the links that are kept up throughout a warm restart (e.g., by maintaining the configuration of the links at ports 535a-c). In some implementations, the reinitialization and rest of the switch hardware may be initialized and the warm restart forwarded to other components (e.g., 530, 540, 545, etc.) using the respective drivers (e.g., 555, 560, 565) of these components. Accordingly, these drivers (e.g., implemented as kernel drivers) for the userspace dataplane and the accelerator blocks cause respective cleanups to be performed for these components. When these cleanups are completed, the drivers may report back to check in when complete. When all these drivers are ready, the userspace application 550 can be launched/re-launched. This allows the customer application 550 to be updated or restarted more quickly, without losing control traffic, all while maintaining the configuration and active state (link up) of the links 525a-c (e.g., maintaining PTP synchronization) to keep the links up throughout the warm restart.

In some implementations, application 550 represents multiple concurrent applications. In such instances, one of the applications may act as the primary instantiation and be responsible for coordinating with the switch API 605. In this sense, the main control plane application that is triggering the warm restart is kept running and does not require re-launch (although other control plane and data plane applications may be re-launched).

As introduced above, in some implementations, a processor device 505 may be configured to support a warm restart, which includes a quick clean-up of resources, without major impact on a board state. To avoid major system downtime during warm restart the physical link state is preserved (e.g., all enabled and up links should not undergo reconfiguration and are kept up, port/lane Media Access Controller Security (IEEE 802.1AE MACSec) configuration and function are preserved, configuration required for LAN flows to function are preserved (e.g., short connectivity disturbance on LAN flows of no longer than 500 ms is acceptable but not desirable), etc.) throughout the warm restart. For switch configurations that are not required for LAN flows to function, these configurations (and the corresponding switch resources (e.g., table and register values) may be removed (e.g., switch configuration reset to startup/default configuration). NIC configuration related to fast-path packet processing may be reset (e.g., fast-path HW queues, etc.), with other portions of the NIC not reset or reconfigured. In some implementations, a total warm restart procedure/sequence is able to complete more quickly (e.g., in less than 5 seconds) than a typical full hardware reset, which may take a minute or longer in some implementations to complete (e.g., including PTP resynchronization), among other examples.

The various drivers of the SoC may communicate to coordinate the warm restart. Communication between drivers may be facilitated through a hardware mailbox, inter-driver communication channels, or other solutions. A call to enter warm restart may be made/received from an application (e.g., a given thread within user space) that is asynchronous from the application point of view, and may return as soon as the warm restart has been successfully initiated without blocking until the warm restart has fully completed. Generally, if the system is able to perform the warm restart (e.g., no other restart has been initiated prior to the call and has not yet completed), the warm restart may cause a switch component to be restarted and reinitialized and a utility in the system (e.g., one of the drivers, an API, etc.) may forward the warm restart request to the drivers of the other components in the system (e.g., accelerator blocks) and manage the drivers' reports back that corresponding reinitialization cleanup has been completed at the respective components. When successful cleanup is reported by those components for which reinitialization is desired or needed, the warm restart may complete and data traffic may resume on the switch and NIC.

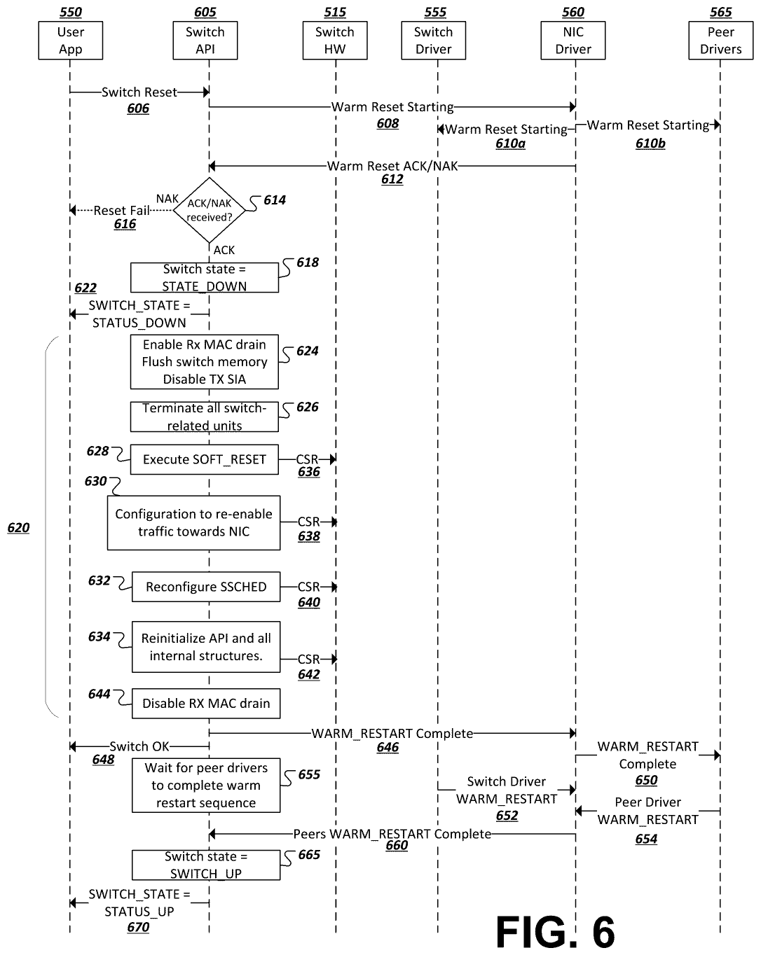

FIG. 6 is a flow diagram 600 illustrating one example of the warm restart progression. In one example, a warm restart is initiated through an API 605 of the switch, through which a switch reset call 606 may be sent from an application 550. As a virtual interface and software switching peer driver is affected by a warm restart and does not have a dedicated hardware mailbox (e.g., because it does not own a piece of physical hardware and thus will not have a hardware mailbox), the switch API 605 may start by conveying a mailbox message 608 to the NIC driver 560 to indicate that the warm restart sequence is beginning. The NIC driver 560 will then convey a notification (e.g., 610a-b) of the warm restart to the other drivers of components affected by the warm restart (e.g., which have resources that should be reinitialized, cleaned, or reset). For instance, the NIC driver 560 may notify the other drivers (e.g., 555, 565) using an IDC event message (e.g., a WARM_RESTART_STARTING IDC event). The NIC driver 560 may send an acknowledgement (ACK) or non-acknowledgment (NAK) to the switch API 605 (e.g., based on a determination that no other reset is in progress or otherwise supersedes the warm restart). In cases where a NAK is instead received in response to the warm restart starting event (e.g., as determined at 614), the switch API 605 may communicate a failed reset 616 (e.g., an ERROR_FAIL return to the warm restart call 606) to the application 550.

If an ACK is received from the NIC driver 560, the reset and/or reinitialization of the switch hardware 515 may be initiated (e.g., by the switch API 605 by writing the switch 515 registers to initiate that reset). Accordingly, a (e.g., <500 ms) LAN traffic drop interval 620 may be realized. In some implementations, communication channels between the drivers (e.g., IDC and mailbox) stay up and available for the duration of the warm restart, for instance, the component drivers (e.g., 555, 560, 565, etc.) are not removed from the IDC virtual bus (e.g., as would be the case in full resets). In some implementations, drivers that may participate in the warm restart may be expected to support and participate in a warm restart at any point other than when another reset is already in progress. For instance, if an application (e.g., 550) calls the switch API 605 to request 606 a warm restart when another reset (e.g., a full reset) is ongoing, when the switch API 605 sends the warm restart starting mailbox message 608 to the NIC driver 560, the NIC driver 560 will respond with a NAK (e.g., at 612), and the switch API 605 will return an error code 616 (e.g., (e.g., an ERROR_FAIL return to the warm restart call 606) to the caller application (e.g., 550), otherwise, the NIC driver 560 is to respond (at 612) with an ACK, indicating that the warm restart sequence can proceed.

In some implementations, in response to the warm restart call 606 (e.g., and an ACK 612 from the NIC driver 560 (or another utility serving to coordinate the warm restart among the drivers (e.g., 555, 560, 565) of the other components of the system), the switch API 605 may set the switch state to DOWN (at 618). In some instances, the NIC driver 560 notifies (e.g., at 610a-b) the other drivers of the warm restart upon determining that the warm restart can proceed (and an ACK should be sent back to the switch API 605). In other cases, the notification events (e.g., 610a-b) may be propagated to the other drivers based on the switch state transitioning to DOWN (at 618) following a warm restart request, among other examples. In some example implementations, the switch API 605 or other process can assert an interrupt (e.g., an RTE_ETH_EVENT_INTR_RMV event) to the interrupt handler thread of an application (e.g., 550). Upon receiving the event, the application 550 stops and closes its network must stop and closes its networking process(es) or threads (e.g., ethdev) or exits. As the application 550 is notified (e.g., 622) that the warm restart is beginning, the traffic drop window associated with the warm restart begins. In some implementations, the warm restart traffic drop window 620 begins immediately without waiting for all applications to acknowledge. The warm restart window 620 continues until the switch completes its reinitialization.

In one example, while in the warm restart window 620 the switch API 605 switch state is STATE_DOWN 618, resulting in the blocking of all switch API calls and incoming traffic no longer being classified as LAN traffic. Further, in some implementations, no new ethdevs or inline IPSec security associations (Sas) can be created. In cases, where a driver is managing transmitter timestamping, the driver will clear out any captured timestamps in the userspace shared memory buffer, and will not place any further captured timestamps into the userspace shared memory buffer. In cases where NetD is managing TX timestamping, NetD will clear out any captured timestamps pending in the PHYs and drop any new timestamp-enabled packets. Further, NetD will disable traffic, drop any traffic to/from the dataplane, and disallow any Netlink configuration commands from userspace, among other examples.

The reinitialization of the switch and its resources may encompass the resetting and reinitialization of various switch tables, configurations, and other settings. In the example of FIG. 6, upon bringing the switch state into a down state (at 618) in connection with a warm restart, the receiver MAC drain is enabled, switch memory is flushed, and the transmitter switch interface adapter (SIA) is disabled (at 624) to begin the traffic drop window 620. All switch-related units (e.g., implementing the switch API software) are disabled 626 and a Soft Reset (e.g., to perform the reset of the switch by clearing all the classification tables and putting back all of the switch registers to their default states or values) is executed 628. The switch is reconfigured 630 to reenable traffic toward the NIC and the scheduler is reconfigured 632. The switch API 605 and all of its internal structures are reinitialized 634 and corresponding configuration status register (CSR) updates (e.g., 636, 638, 640, 642) to record the completion of these switch reconfiguration activities. With the switch reinitialized, the receiver MAC drain is disabled to complete the reset of the switch and end the traffic drop window 620.

Continuing with the example of FIG. 6, when the initial phase of the warm restart has completed, such as the restart of the switch hardware (e.g., and the corresponding initial <500 ms traffic drop interval 620), the switch API 605 sends a message 646 (e.g., a mailbox or IDC message) to the NIC driver 560 indicating that the restart-related cleanup of the switch hardware 515 resources is complete. Additionally, the switch API 605 may finally send a return 648 to the initial warm restart call 606 to indicate that the warm restart has been initiated. The NIC driver 560 may react to the message 646 by conveying a warm restart IDC event (e.g., 650) to one or more of the other component's drivers. As the other drivers may orchestrate the clean up of their respective resources asynchronously with the cleanup performed at the switch (and in parallel with the warm restart traffic down window 620), when the warm restart complete message 646 and warm restart complete event 650 are sent, clean up at one of the components (e.g., the NIC, an accelerator, etc.) may already be complete or ongoing.

After each peer driver (e.g., 555, 565, etc.) finishes its respective cleanup, the driver send a notification to the entity monitoring the cleanups (e.g., in this case the NIC driver 560), for instance, by sending a WARM_RESTART_PEER_DRV_DONE message (e.g., 652, 654). If a peer driver (e.g., 555, 565) finishes its cleanup early, it can send its notification message (e.g., 652, 654) right away; it does not need to wait until it has received WARM_RESTART_COMPLETE IDC event (e.g., 650). Once all peer drivers have checked in, the warm restart is considered complete. At that point, with respect to the userspace dataplane, the system will be in the same clean state as after a full hardware reset (e.g., whereas, during the warm restart, only the hardware 515 of the switch is reset). In this example, as the switch API 605 runs in userspace and does not have direct access to IDC events, the switch API waits 655 for the NIC driver 560 (or another entity designated as managing the cleanup status check-in) to report that the cleanup of the other components has completed. For instance, the NIC driver may maintain the authoritative list of which peer drivers have completed their respective cleanups. For instance, the NIC driver 560 may compare this list to the peer drivers that are loaded in the system (e.g., it is a valid use case to perform a warm restart even when fewer than all peer drivers are present). When all loaded peer drivers have reported the completion of their cleanup activities, the NIC driver 560 may send a mailbox message 660 to the switch API 605 indicating the same. Upon receipt of this mailbox message 660, the switch API 605 may update the switch state to a “SWITCH_UP” state (at 665) and will advertise (at 670) that the switch up again. At that point, applications 550 may be launched again and utilize the networking functionality provided by the processor device.

Once all peer drivers have completed their portion of the warm restart, the warm restart window finishes, the switch API sets the switch state back to UP, and the DSI dataplane is in a clean state ready for applications, the same as it would be after a full device reset. If an error or other issue is detected during the warm restart flow, the warm restart may be upgraded to a full device reset. For instance, if the NIC encounters an issue while performing the warm restart, and the NIC HW triggers a CORER, the flow will transition to a full hardware reset. The NIC driver, in such as case, may send a WARN_RESET IDC event to the peer drivers, and the peer drivers will be removed from the bus as per a typical full reset flow. For other software failures that drivers may encounter during the warm restart flow, the switch API will not receive a PEER_DRV_DONE event from all drivers, so it will not advertise switch up within the designated (e.g., five-second) warm restart window. In this case, it will be up to the application to respond to this delay by triggering a full hardware reset, reload the driver stack, reboot the system, or take other recovery actions. Accordingly, a switch API may permit a user to trigger a full hardware reset in the case of a warm restart that does not complete within the warm restart window.

It is assumed that peer drivers will not be loaded or unloaded during the warm restart interval. In the case where a warm restart is initiated while an application is still running, and the application takes several seconds or more to clean up, during the interval when LAN traffic is no longer dropped, but some of the peer drivers are still performing cleanup, all incoming traffic will be treated as LAN traffic. Since the switch API is not yet advertising switch up, no userspace applications can use the switch API to program rules to classify certain flows as application traffic. Therefore, if high-bandwidth ingress flows continue, the LAN queues will fill up and packets will be dropped. This may be an issue with respect to the PTP stack, as 10+ Gbps of application traffic will overwhelm the several hundred packets per second of PTP traffic, and PTP sync may not be maintainable despite the LAN flows technically being up, among other example issues.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

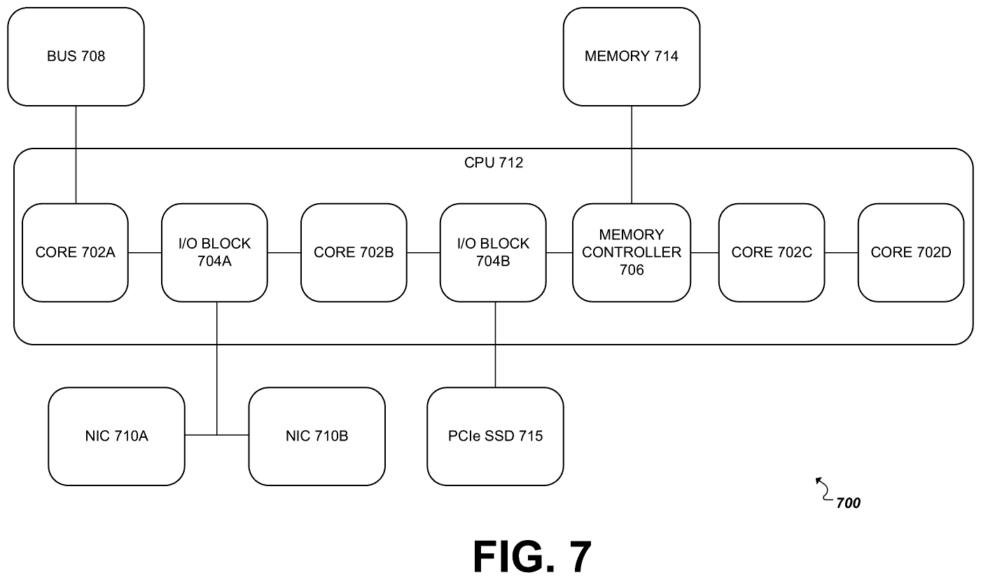

Note that the apparatus', methods', and systems described above may be implemented in any electronic device or system as aforementioned. More particularly, a preprocessing hardware accelerator, such as discussed herein, may be coupled to or integrated in a variety of different electronic devices or system to offload certain preprocessing tasks, including data reduction operations, from other processing hardware (e.g., a CPU) of the system. As a specific illustration, FIG. 7 provides an exemplary implementation of a processing device such as one that may be included in a networking device, such as a wireless base station, router, data center networking SoC, or other device. or other environment to provide networking or be coupled to and use a preprocessing hardware accelerator (e.g., to offload workloads to). It should be appreciated that other processor architectures may be provided to implement the functionality and processing of requests by an example network processing device, including the implementation of the example network processing device components and functionality discussed above. Further, it should be appreciated that the principles discussed herein are network and interconnect protocol agnostic and may be applied to a variety of other technologies.

Referring to FIG. 7, a block diagram 700 is shown of an example data processor device (e.g., a central processing unit (CPU)) 712 coupled to various other components of a platform in accordance with certain embodiments. Although CPU 712 depicts a particular configuration, the cores and other components of CPU 712 may be arranged in any suitable manner. CPU 712 may comprise any processor or processing device, such as a microprocessor, an embedded processor, a digital signal processor (DSP), a network processor, an application processor, a co-processor, a system on a chip (SOC), or other device to execute code. CPU 712, in the depicted embodiment, includes four processing elements (cores 702 in the depicted embodiment), which may include asymmetric processing elements or symmetric processing elements. However, CPU 712 may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core may refer to logic located on an integrated circuit capable of maintaining an independent architectural state, wherein each independently maintained architectural state is associated with at least some dedicated execution resources. A hardware thread may refer to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical CPU 712, as illustrated in FIG. 7, includes four cores-cores 702A, 702B, 702C, and 702D, though a CPU may include any suitable number of cores. Here, cores 702 may be considered symmetric cores. In another embodiment, cores may include one or more out-of-order processor cores or one or more in-order processor cores. However, cores 702 may be individually selected from any type of core, such as a native core, a software managed core, a core adapted to execute a native Instruction Set Architecture (ISA), a core adapted to execute a translated ISA, a co-designed core, or other known core. In a heterogeneous core environment (e.g., asymmetric cores), some form of translation, such as binary translation, may be utilized to schedule or execute code on one or both cores.

A core 702 may include a decode module coupled to a fetch unit to decode fetched elements. Fetch logic, in one embodiment, includes individual sequencers associated with thread slots of cores 702. Usually a core 702 is associated with a first ISA, which defines/specifies instructions executable on core 702. Often machine code instructions that are part of the first ISA include a portion of the instruction (referred to as an opcode), which references/specifies an instruction or operation to be performed. The decode logic may include circuitry that recognizes these instructions from their opcodes and passes the decoded instructions on in the pipeline for processing as defined by the first ISA. For example, as decoders may, in one embodiment, include logic designed or adapted to recognize specific instructions, such as transactional instructions. As a result of the recognition by the decoders, the architecture of core 702 takes specific, predefined actions to perform tasks associated with the appropriate instruction. It is important to note that any of the tasks, blocks, operations, and methods described herein may be performed in response to a single or multiple instructions; some of which may be new or old instructions. Decoders of cores 702, in one embodiment, recognize the same ISA (or a subset thereof). Alternatively, in a heterogeneous core environment, a decoder of one or more cores (e.g., core 702B) may recognize a second ISA (either a subset of the first ISA or a distinct ISA).

In various embodiments, cores 702 may also include one or more arithmetic logic units (ALUs), floating point units (FPUs), caches, instruction pipelines, interrupt handling hardware, registers, or other suitable hardware to facilitate the operations of the cores 702.

Bus 708 may represent any suitable interconnect coupled to CPU 712. In one example, bus 708 may couple CPU 712 to another CPU of platform logic (e.g., via UPI). I/O blocks 704 represents interfacing logic to couple I/O devices 710 and 715 to cores of CPU 712. In various embodiments, an I/O block 704 may include an I/O controller that is integrated onto the same package as cores 702 or may simply include interfacing logic to couple to an I/O controller that is located off-chip. As one example, I/O blocks 704 may include PCIe interfacing logic. Similarly, memory controller 706 represents interfacing logic to couple memory 714 to cores of CPU 712. In various embodiments, memory controller 706 is integrated onto the same package as cores 702. In alternative embodiments, a memory controller could be located off chip.

As various examples, in the embodiment depicted, core 702A may have a relatively high bandwidth and lower latency to devices coupled to bus 708 (e.g., other CPUs 712) and to NICs 710, but a relatively low bandwidth and higher latency to memory 714 or core 702D. Core 702B may have relatively high bandwidths and low latency to both NICs 710 and PCIe solid state drive (SSD) 715 and moderate bandwidths and latencies to devices coupled to bus 708 and core 702D. Core 702C would have relatively high bandwidths and low latencies to memory 714 and core 702D. Finally, core 702D would have a relatively high bandwidth and low latency to core 702C, but relatively low bandwidths and high latencies to NICs 710, core 702A, and devices coupled to bus 708.

“Logic” (e.g., as found in I/O controllers, power managers, latency managers, etc. and other references to logic in this application) may refer to hardware, firmware, software and/or combinations of each to perform one or more functions. In various embodiments, logic may include a microprocessor or other processing element operable to execute software instructions, discrete logic such as an application specific integrated circuit (ASIC), a programmed logic device such as a field programmable gate array (FPGA), a memory device containing instructions, combinations of logic devices (e.g., as would be found on a printed circuit board), or other suitable hardware and/or software. Logic may include one or more gates or other circuit components. In some embodiments, logic may also be fully embodied as software.

A design may go through various stages, from creation to simulation to fabrication. Data representing a design may represent the design in a number of manners. First, as is useful in simulations, the hardware may be represented using a hardware description language (HDL) or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In some implementations, such data may be stored in a database file format such as Graphic Data System II (GDS II), Open Artwork System Interchange Standard (OASIS), or similar format.

In some implementations, software-based hardware models, HDL, and other functional description language objects can include register transfer language (RTL) files, among other examples. Such objects can be machine-parsable such that a design tool can accept the HDL object (or model), parse the HDL object for attributes of the described hardware, and determine a physical circuit and/or on-chip layout from the object. The output of the design tool can be used to manufacture the physical device. For instance, a design tool can determine configurations of various hardware and/or firmware elements from the HDL object, such as bus widths, registers (including sizes and types), memory blocks, physical link paths, fabric topologies, among other attributes that would be implemented in order to realize the system modeled in the HDL object. Design tools can include tools for determining the topology and fabric configurations of a system on chip (SoC) and other hardware devices. In some instances, the HDL object can be used as the basis for developing models and design files that can be used by manufacturing equipment to manufacture the described hardware. Indeed, an HDL object itself can be provided as an input to manufacturing system software to cause the described hardware.

In any representation of the design, the data may be stored in any form of a machine readable medium. A memory or a magnetic or optical storage such as a disc may be the machine-readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘to’ or ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example, the decimal number ten may also be represented as a binary value of 418A0 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, e.g., a reset, while an updated value potentially includes a low logical value, e.g., a set. Note that any combination of values may be utilized to represent any number of states.

The embodiments of methods, hardware, software, firmware, or code set forth above may be implemented via instructions or code stored on a machine-accessible, machine readable, computer accessible, or computer readable medium which are executable by a processing element. A non-transitory machine-accessible/readable medium includes any mechanism that provides (e.g., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

The following examples pertain to embodiments in accordance with this Specification. Example 1 is a non-transitory machine-readable storage medium with instructions stored thereon, the instructions executable by a machine to cause the machine to: identify a request to initiate a warm restart at a network processor device, where the network processor device includes a processor to execute an application, a switch, one or more hardware components, and physical layer circuitry to implement one or more communication links, where the switch is to be reset during the warm restart while the one or more communication links remain in an up state; send a notification of the warm restart to a set of drivers for the one or more hardware components; receive notifications from the set of drivers, where the notifications identify that reinitializations of the one or more hardware components associated with the warm restart are complete; and send an indication that the reinitializations of the one or more hardware components are complete, where completion of the warm restart is to be based on the indication.

Example 2 includes the subject matter of example 1, where the network processor device further includes a network interface controller (NIC) coupled to the switch.

Example 3 includes the subject matter of example 2, where one or more hardware components include a hardware accelerator device, and the set of drivers include a first driver for the switch and a second driver for the accelerator device.

Example 4 includes the subject matter of any one of examples 2-3, where a driver of the NIC sends the notification of the warm restart to the set of drivers, receives the notifications from the set of drivers, and sends the indication that the reinitializations are complete.

Example 5 includes the subject matter of any one of examples 2-4, where hardware of the switch is to be brought to a down state during the reset of the switch in the warm restart, and hardware of the NIC and hardware of the one or more hardware components are to remain in an up state during the warm restart.

Example 6 includes the subject matter of example 5, where the reinitialization of one of the one or more hardware components includes a cleanup of a data structure used in configuration of the one of the one or more hardware components.

Example 7 includes the subject matter of any one of examples 5-6, where the reinitializations of the one or more hardware components is performed asynchronously with the reset of the hardware of the switch.

Example 8 includes the subject matter of any one of examples 1-7, where the instructions are further executable to cause the machine to record the notifications from the set of drivers to determine when a respective notification has been received from each of the set of drivers and that the reinitialization of each of the one or more hardware components has been completed, where the indication is sent in response to a determination that the reinitialization of each of the one or more hardware components has been completed.

Example 9 includes the subject matter of any one of examples 1-8, where data plane traffic is blocked during the warm restart and control plane traffic is communicated on the communications links and processed by the network processor device during the warm restart.

Example 10 includes the subject matter of example 9, where the control plane traffic includes Precision Time Protocol (PTP) data.

Example 11 includes the subject matter of any one of examples 1-10, where the warm restart is triggered by the application.

Example 12 includes the subject matter of any one of examples 1-11, where the warm restart is triggered in association with an update or a relaunch of the application.

Example 13 is a method including: identifying a request to initiate a warm restart at a network processor device, where the network processor device includes a processor to execute an application, a switch, one or more hardware components, and physical layer circuitry to implement one or more communication links, where the switch is to be reset during the warm restart while the one or more communication links remain in an up state; sending a notification of the warm restart to a set of drivers for the one or more hardware components to trigger reinitialization of the corresponding one or more hardware components; receiving notifications from the set of drivers identifying that respective reinitializations of the corresponding one or more hardware components are complete; and sending an indication that the reinitializations of the one or more hardware components are complete to trigger completion of the warm restart.

Example 14 includes the subject matter of example 13, where data plane traffic is dropped during the warm restart and control plane traffic is consumed during the warm restart.

Example 15 includes the subject matter of example 14, where the control plane traffic includes Precision Time Protocol (PTP) data.

Example 16 includes the subject matter of any one of examples 13-15, where the switch transitions from an up state to a down state based on the reset of the switch, the indication is sent to the switch, and the method further includes: returning the switch to the upstate; and notifying the application that the switch is up and the warm restart is complete.

Example 17 includes the subject matter of any one of examples 13-16, where the network processor device further includes a network interface controller (NIC) coupled to the switch.

Example 18 includes the subject matter of example 17, where one or more hardware components include a hardware accelerator device, and the set of drivers include a first driver for the switch and a second driver for the accelerator device.

Example 19 includes the subject matter of any one of examples 17-18, where a driver of the NIC sends the notification of the warm restart to the set of drivers, receives the notifications from the set of drivers, and sends the indication that the reinitializations are complete.

Example 20 includes the subject matter of any one of examples 17-19, where hardware of the switch is to be brought to a down state during the reset of the switch in the warm restart, and hardware of the NIC and hardware of the one or more hardware components are to remain in an up state during the warm restart.

Example 21 includes the subject matter of example 20, where the reinitialization of one of the one or more hardware components includes a cleanup of a data structure used in configuration of the one of the one or more hardware components.

Example 22 includes the subject matter of any one of examples 20-21, where the reinitializations of the one or more hardware components is performed asynchronously with the reset of the hardware of the switch.

Example 23 includes the subject matter of any one of examples 13-22, further including recording the notifications from the set of drivers to determine when a respective notification has been received from each of the set of drivers and that the reinitialization of each of the one or more hardware components has been completed, where the indication is sent in response to a determination that the reinitialization of each of the one or more hardware components has been completed.

Example 24 includes the subject matter of any one of examples 13-23, where data plane traffic is blocked during the warm restart and control plane traffic is communicated on the communications links and processed by the network processor device during the warm restart.

Example 25 includes the subject matter of any one of examples 13-24, where the warm restart is triggered by the application.

Example 26 includes the subject matter of any one of examples 13-25, where the warm restart is triggered in association with an update or a relaunch of the application.

Example 27 is a system including means to perform the method of any one of examples 13-26.

Example 28 is a system including: a switch; at least one hardware accelerator; physical layer circuitry to implement one or more communication links; a processor to execute an application and implement a set of drivers, where the set of drivers includes a driver of the switch and a driver of the hardware accelerator, where a given driver in the set of drivers is to: identify a request from the application to initiate a warm restart in the system, where the switch is to be reset during the warm restart while the one or more communication links remain in an active state to receive data; notify other drivers in the set of drivers of the warm restart; determine that reinitializations of components associated with the set of drivers are complete; and send an indication that the reinitializations of the components associated with the set of drivers are complete, where the warm restart is to be completed based on the indication.

Example 29 includes the subject matter of example 28, including a network processor device including the switch, the hardware accelerator, and the processor.

Example 30 includes the subject matter of any one of examples 28-29, further including a networking device for a wireless access network, where the networking device includes the network processor device.

Example 31 includes the subject matter of example 30, where the application is to control data handling by the network device in the wireless access network.

Example 32 includes the subject matter of any one of examples 28-31, where the hardware accelerator includes one of a data compression accelerator, a data decompression accelerator, a cryptographic accelerator, a network security accelerator, or a machine learning accelerator.

Example 33 includes the subject matter of any one of examples 28-32, further including a network interface controller (NIC) coupled to the switch.

Example 34 includes the subject matter of example 33, where one or more hardware components include a hardware accelerator device, and the set of drivers include a first driver for the switch and a second driver for the accelerator device.

Example 35 includes the subject matter of any one of examples 33-34, where a driver of the NIC sends the notification of the warm restart to the set of drivers, receives the notifications from the set of drivers, and sends the indication that the reinitializations are complete.

Example 36 includes the subject matter of any one of examples 33-35, where hardware of the switch is to be brought to a down state during the reset of the switch in the warm restart, and hardware of the NIC and hardware of the one or more hardware components are to remain in an up state during the warm restart.

Example 37 includes the subject matter of any one of examples 33-36, where the reinitialization of one of the one or more hardware components includes a cleanup of a data structure used in configuration of the one of the one or more hardware components.

Example 38 includes the subject matter of example 37, where the reinitializations of the one or more hardware components is performed asynchronously with the reset of the hardware of the switch.

Example 39 includes the subject matter of any one of examples 28-38, where the given driver is further executable to cause the machine to record the notifications from the set of drivers to determine when a respective notification has been received from each of the set of drivers and that the reinitialization of each of the one or more hardware components has been completed, where the indication is sent in response to a determination that the reinitialization of each of the one or more hardware components has been completed.

Example 40 includes the subject matter of any one of examples 28-39, where data plane traffic is blocked during the warm restart and control plane traffic is communicated on the communications links and processed by the network processor device during the warm restart.

Example 41 includes the subject matter of example 40, where the control plane traffic includes Precision Time Protocol (PTP) data.

Example 42 includes the subject matter of any one of examples 28-41, where the warm restart is triggered by the application.

Example 43 includes the subject matter of any one of examples 28-42, where the warm restart is triggered in association with an update or a relaunch of the application.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. At least one non-transitory machine-readable storage medium with instructions stored thereon, the instructions executable by a machine to cause the machine to:
identify a request to initiate a warm restart at a network processor device, wherein the network processor device comprises a processor to execute an application, a switch, one or more hardware components, and physical layer circuitry to implement one or more communication links, wherein the switch is to be reset during the warm restart while the one or more communication links remain in an up state;
send a notification of the warm restart to a set of drivers for the one or more hardware components;
receive notifications from the set of drivers, wherein the notifications identify that reinitializations of the one or more hardware components associated with the warm restart are complete; and
send an indication that the reinitializations of the one or more hardware components are complete, wherein completion of the warm restart is to be based on the indication.

2. The storage medium of claim 1, wherein the network processor device further comprises a network interface controller (NIC) coupled to the switch.

3. The storage medium of claim 2, wherein one or more hardware components comprise a hardware accelerator device, and the set of drivers comprise a first driver for the switch and a second driver for the accelerator device.

4. The storage medium of claim 2, wherein a driver of the NIC sends the notification of the warm restart to the set of drivers, receives the notifications from the set of drivers, and sends the indication that the reinitializations are complete.

5. The storage medium of claim 2, wherein hardware of the switch is to be brought to a down state during the reset of the switch in the warm restart, and hardware of the NIC and hardware of the one or more hardware components are to remain in an up state during the warm restart.

6. The storage medium of claim 5, wherein the reinitialization of one of the one or more hardware components comprises a cleanup of a data structure used in configuration of the one of the one or more hardware components.

7. The storage medium of claim 5, wherein the reinitializations of the one or more hardware components is performed asynchronously with the reset of the hardware of the switch.

8. The storage medium of claim 1, wherein the instructions are further executable to cause the machine to record the notifications from the set of drivers to determine when a respective notification has been received from of the drivers in the set of drivers and that the reinitialization of each of the one or more hardware components has been completed, wherein the indication is sent in response to a determination that the reinitialization of each of the one or more hardware components has been completed.

9. The storage medium of claim 1, wherein data plane traffic is blocked during the warm restart and control plane traffic is communicated on the communications links and processed by the network processor device during the warm restart.

10. The storage medium of claim 9, wherein the control plane traffic comprises Precision Time Protocol (PTP) data.

11. The storage medium of claim 1, wherein the network processor device comprises a processor to execute an application.

12. The storage medium of claim 11, wherein the warm restart is triggered by the application.

13. The storage medium of claim 11, wherein the warm restart is triggered in association with an update or a relaunch of the application.

14. A method comprising:
identifying a request to initiate a warm restart at a network processor device, wherein the network processor device comprises a processor to execute an application, a switch, one or more hardware components, and physical layer circuitry to implement one or more communication links, wherein the switch is to be reset during the warm restart while the one or more communication links remain in an up state;
sending a notification of the warm restart to a set of drivers for the one or more hardware components to trigger reinitialization of the corresponding one or more hardware components;
receiving notifications from the set of drivers identifying that respective reinitializations of the corresponding one or more hardware components are complete; and
sending an indication that the reinitializations of the one or more hardware components are complete to trigger completion of the warm restart.

15. The method of claim 14, wherein data plane traffic is dropped during the warm restart and control plane traffic is consumed during the warm restart.

16. The method of claim 14, wherein the switch transitions from an up state to a down state based on the reset of the switch, the indication is sent to the switch, and the method further comprises:
returning the switch to the upstate; and
notifying the application that the switch is up and the warm restart is complete.

17. A system comprising:
a switch;
at least one hardware accelerator;
physical layer circuitry to implement one or more communication links;
a processor to execute an application and implement a set of drivers, wherein the set of drivers comprises a driver of the switch and a driver of the hardware accelerator,
wherein a given driver in the set of drivers is to:
identify a request from the application to initiate a warm restart in the system, wherein the switch is to be reset during the warm restart while the one or more communication links remain in an active state to receive data;
notify other drivers in the set of drivers of the warm restart;
determine that reinitializations of components associated with the set of drivers are complete; and
send an indication that the reinitializations of the components associated with the set of drivers are complete, wherein the warm restart is to be completed based on the indication.

18. The system of claim 17, comprising a network processor device comprising the switch, the hardware accelerator, and the processor.

19. The system of claim 17, further comprising a networking device for a wireless access network, wherein the networking device comprises the network processor device and the application is to control data handling by the network device in the wireless access network.

20. The system of claim 17, wherein the hardware accelerator comprises one of a data compression accelerator, a data decompression accelerator, a cryptographic accelerator, a network security accelerator, or a machine learning accelerator.
